(19) United States
(12) Patent Application Publication
(10) Pub. No.: US 2026/0291430 A1
(43) Pub. Date: Sep. 24, 2026

(54) SOLAR SITE NETWORK

(71) Applicant: ARRAY TECH, INC., Albuquerque, NM (US)

(72) Inventors: Imanol Olazarri, Pamplona (ES); Iñigo Garcia Colomo, Pamplona (ES); Aitor Gomez, Pamplona (ES); Javier Ibarrola Garcia, Pamplona (ES)

(21) Appl. No.: 19/564,725

(22) Filed: Mar. 12, 2026

Related U.S. Application Data
(60) Provisional application No. 63/775,668, filed on Mar. 21, 2025.

(51) Int. Cl. H02S 40/12; F24S 30/00; F24S 30/428; F24S 40/20; H02S 20/32; H04W 4/38

(52) U.S. Cl. CPC H02S 40/12; F24S 30/428; F24S 40/20; H02S 20/32; F24S 2030/11; H04W 4/38

(57) ABSTRACT

A local site network for controlling a solar tracking system may include a first communication system communicatively coupled with a second communication system. The first communication system may include a first photovoltaic (PV) module controller configured to cause a first set of PV modules to rotate based on weather data and a first system network controller communicatively coupled to the first PV module controller and configured to send weather data to the first PV module controller. The second communication system may include a second PV module controller configured to cause a second set of PV modules to rotate based on the weather data and a second system network controller communicatively coupled to the second PV module controller and configured to send the weather data to the second PV module controller. The system network controllers may include modems coupling the system network controllers via a cellular network standard.

### CROSS-REFERENCE TO RELATED APPLICATIONS

This patent application claims priority to and the benefit of U.S. Provisional Patent Application Ser. No. 63/775,668, entitled AUTONOMOUS SOLAR SITE NETWORK, filed Mar. 21, 2025, which is incorporated by reference in its entirety.

### FIELD

The present disclosure relates to solar energy production and more particularly to a solar site network.

### BACKGROUND

Solar tracking systems operate by rotating PV modules to align with the Sun's position, and to maximize the PV module's exposure to sunlight throughout the day. This functionality ensures that PV modules in solar tracking systems remain positioned to capture increased levels of solar radiation, thereby enhancing the overall efficiency of solar power generation.

Solar tracking systems typically rely on external communication networks such as local area networks (LANs) to coordinate the rotation of the PV modules and respond to weather conditions. These external networks may require extensive infrastructure including cabling, inverters, and/or supervisory control and data acquisition (SCADA) systems to be installed and commissioned before the solar tracking system may facilitate movement of the PV modules. As a result, conventional solar tracker systems may face challenges during the construction phase of a solar tracking system because the external communications infrastructure is typically not yet operational.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used to limit the scope of the claimed subject matter.

The assembly and commissioning of solar tracker systems often occurs well before the establishment of an on-site external network. This may result in a months-long period where installed trackers lack the ability to communicate with weather monitoring systems such as weather controllers or centralized control units such as system network controllers. Without access to real-time weather data or an ability to mobilize solar trackers in response to the weather data, solar tracking systems may be unable to implement protective measures such as stow positioning during high wind events, hailstorms, or other weather events. The absence of early-stage communication networks during the construction of solar tracking systems may leave PV modules vulnerable to damage due to these weather events, potentially leading to significant repair costs, replacement costs, and/or project delays.

Moreover, the setup of an operational network infrastructure concurrently with the commissioning of the solar tracking systems often requires additional time and resources, potentially prolonging the overall construction schedule and increasing costs. Thus, the inability of network controllers to communicate effectively until the necessary communication infrastructure is fully operational may impede deployment of solar tracking systems.

Accordingly, there exists a need for a local site network for controlling a solar tracking system that may function prior to the availability of an external network. Such systems may facilitate the sharing of weather data and allow for protective measures to be implemented before network infrastructure is installed.

Additionally, solar tracker systems that may operate independently of external networks may provide increased flexibility and reliability throughout the lifecycle of a solar tracking system. This may be particularly beneficial in remote locations or in scenarios where the primary communication network experiences outages.

A potential solution to problems associated with the inability to communicate weather data without external network infrastructure may include having the centralized control units, such as system network controllers, each be paired via a local site network with a respective weather controller. As a result, each system network controller may be able to receive weather data from the weather controller without access to an external network. However, in a solar tracking system, there may be many system network controllers, and this solution may require an individual weather controller for each system network controller, which may increase the cost of a solar tracking system. Furthermore, weather controllers may be up to 30 feet tall or higher, which may cast shadows on surrounding PV modules thereby reducing the effectiveness of the solar tracking system in generating energy. As a result, weather controllers are typically situated on the periphery of a solar tracking system to mitigate the effects of the shadows, and typically a small number of weather controllers are utilized. For example, only one or two weather controllers may be utilized.

At least some of the example embodiments of the present disclosure address problems experienced in solar tracking systems, including problems associated with stowing PV modules during adverse weather conditions due to the inability to communicate weather data without external network infrastructure. In some embodiments, the operational capabilities of solar tracking systems may be enhanced by integrating an advanced local site network that facilitates communication between system components over a cellular network standard, ensuring that PV modules may be promptly and efficiently stowed in response to changing weather conditions without having to wait for an external network to be configured and commissioned. The advanced local site network may be particularly useful during the construction phase of a solar tracking system.

The local site network may include multiple communication systems. A first communication system includes a first PV module controller that may cause a first set of PV modules to rotate based on weather data and a first system network controller communicatively coupled to the first PV module controller. The first system network controller may send the weather data to the first PV module controller and may include a modem. A second communication system is communicatively coupled to the first communication system. The second communication system includes a second PV module controller that may cause a second set of PV modules to rotate based on the weather data and a second system network controller communicatively coupled to the second PV module controller. The second system network controller may send the weather data to the second PV module controller and may also include a modem. The modem of the first system network controller and the modem of the second system network controller communicatively couple the first communication system and the second communication system via a cellular network standard such as, for example, 5G. Thus, the system network controllers of the first and the second communication system may communicate weather data between the communication systems without waiting for an external local area network to be operational.

In some embodiments, the first communication system may further include a weather controller that may be communicatively coupled to the first system network controller. The weather controller may be configured to collect the weather data. The first system network controller may be configured to send the weather data to the second system network controller via the cellular network standard. In some embodiments, the weather data may include wind data, precipitation data, and/or solar irradiance data. These configurations may facilitate enhanced responsiveness and/or accuracy in positioning PV modules in accordance with real-time environmental changes.

In some embodiments, a first gateway may be included in the first system network controller. The first gateway may communicatively couple the first system network controller to the first PV module controller and/or the weather controller. Similarly, a second gateway may be included in the second system network controller. The second gateway may communicatively couple the second system network controller to the second PV module controller.

In some embodiments, the first PV module controller and the first system network controller and/or the second PV module controller and the second system network controller may be communicatively coupled via a wireless communication protocol. In some embodiments, the weather controller and the first system network controller may be communicatively coupled via a wireless communication protocol.

In some embodiments, the first system network controller and/or the second system network controller may be powered by a generator, a PV module of the first set of PV modules, a PV module of the second set of PV modules, an auxiliary PV module, and/or batteries.

A PV system is also disclosed. The PV system includes a first set of PV modules and a first communication system that may cause the first set of PV modules to rotate based on weather data. The first communication system includes a first PV module controller and a first system network controller, which includes a first modem. A second set of PV modules and a second communication system are further included. The second communication system is communicatively coupled to the first communication system and may cause the second set of PV modules to rotate. The second communication system includes a second PV module controller and a second system network controller, which includes a second modem. The first and second modems communicatively couple the first system network controller and the second system network controller via a cellular network standard such as, for example, 5G. Thus, weather data may be communicated between communication systems such that the first set of PV modules and the second set of PV modules may be rotated based on the weather data even in the absence of an operational external network.

A method of communicating between photovoltaic systems is further provided and may include obtaining weather data via a first communication system that controls a first set of PV modules. The weather data may be sent from the first communication system to a second communication system controlling a second set of PV modules via a cellular network standard, such as, for example, 5G. In response to receiving the weather data, the second set of PV modules may be rotated. In some embodiments, the method may further include rotating the first set of PV modules in response to obtaining the weather data. Thus, weather data may be communicated between communication systems without an external network, and the first set of PV modules and/or the second set of PV modules may be rotated in response to weather data. As a result, the risk of damage to the first set of PV modules and/or the second set of PV modules during weather events may be mitigated.

Overall, the embodiments disclosed may improve solar tracking systems by providing communication capability between different communication systems, allowing the transmission of weather data before traditional network infrastructure is installed and enabling protective measures to be undertaken in response to weather events.

The object and advantages of the embodiments will be realized and achieved at least by the elements, features, and combinations particularly pointed out in the claims. It is to be understood that both the foregoing general description and the following detailed description are explanatory and are not restrictive of the invention, as claimed.

### BRIEF DESCRIPTION OF THE DRAWINGS

Example embodiments will be described and explained with additional specificity and detail through the accompanying drawings in which:

FIG. 1 illustrates an example photovoltaic system including a first communication system and a second communication system;

FIG. 2 illustrates an example local site network for controlling a solar tracking system;

FIG. 3 illustrates an example communication system;

FIGS. 4A and 4B illustrate an example local site network including a first communication system and a second communication system;

FIG. 5 is a flowchart of an example method of communicating between photovoltaic systems; and

FIG. 6 illustrates an example computer system that may be employed in an example photovoltaic system.

All in accordance with one or more embodiments in the present disclosure.

### DETAILED DESCRIPTION

Embodiments of the present disclosure are explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

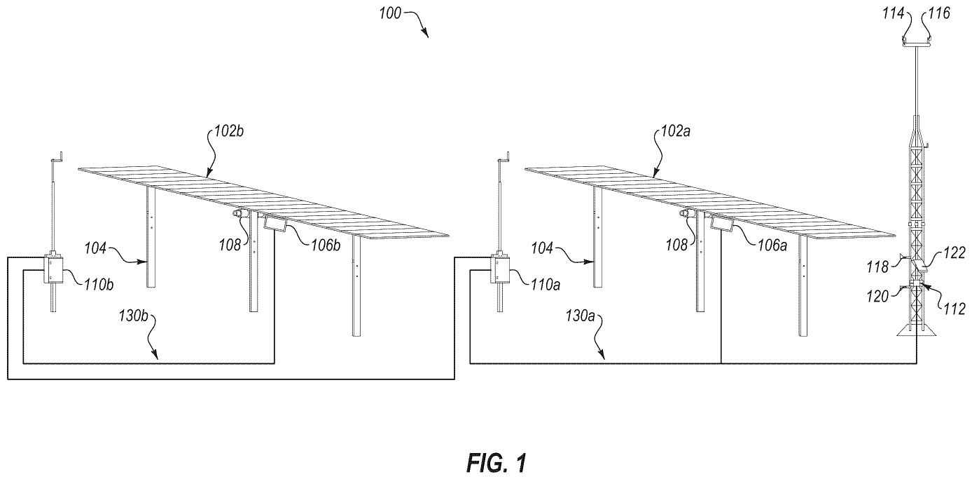

FIG. 1 illustrates an example photovoltaic (PV) system 100. The PV system 100 may include a first set of PV modules 102a and a second set of PV modules 102b (collectively, the sets of PV modules 102). The PV system 100 may also include one or more support columns (or piles) 104, and one or more torque tubes (not shown). The sets of PV modules 102 may each be coupled to a torque tube such that the rotation of the torque tube may be translated to the sets of PV modules 102 enabling the sets of PV modules 102 to track the position of the Sun in the sky throughout the day. For example, as the Sun rises and early in the day, the sets of PV modules 102 may each be rotated by a torque tube such that the sets of PV modules 102 are facing an easterly direction, around mid-day the sets of PV modules 102 may be horizontal, and as the Sun sets and later in the day, the sets of PV modules 102 may each be rotated by a torque tube such that the sets of PV modules 102 are facing a westerly direction. Additionally or alternatively, the sets of PV modules 102 may each be rotated by a torque tube in response to weather events such as hailstorms or snowstorms, for maintenance purposes, and/or in response to other factors other than to track the position of the Sun.

The first set of PV modules 102a may be coupled to a first torque tube such that rotation of the first torque tube rotates the first set of PV modules 102a and the second set of PV modules 102b may be coupled to a second torque tube such that rotation of the second torque tube rotates the second set of PV modules 102b. The support columns 104 may be driven into the ground and may provide vertical support for the first set of PV modules 102a and the first torque tube and the second set of PV modules 102b and the second torque tube. The torque tubes may provide horizontal support to the sets of PV modules 102 and the torque tubes may be rotated by a motor 108.

The PV system 100 may further include a first communication system 130a having a first system network controller 110a, a first PV module controller 106a, and a weather controller 112. The PV system 100 may further include a second communication system 130b communicatively coupled to the first communication system 130a and having a second system network controller 110b and a second PV module controller 106b. The first communication system 130a may allow weather data to be sent from the weather controller 112 to the first PV module controller 106a via the first system network controller 110a, and the first PV module controller 106a may cause the first set of PV modules 102a to rotate based on the weather data. The first communication system 130a may send the weather data from the first system network controller 110a to the second system network controller 110b, which may send the weather data to the second PV module controller 106b. The second PV module controller 106b may cause the second set of PV modules 102b to rotate based on the weather data.

The weather controller 112 may be configured to aggregate and/or analyze weather data such as meteorological data. For example, the weather controller 112 may aggregate and send wind data, precipitation data, and/or solar irradiance data to the first PV module controller 106a via the first system network controller 110a to allow the first PV module controller 106a to adjust the first set of PV modules 102a to track the sun or stow the first set of PV modules 102a in response to certain weather conditions.

The weather controller 112 may collect inputs from various sensors, such as, for example, a wind vane 114, an anemometer 116, a solar sensor 118, and a precipitation sensor 120. The wind vane 114 may measure wind data such as wind direction. The anemometer 116 may also measure wind data such as wind speed. The wind vane 114 and/or the anemometer 116 may also be combined with a barometer to measure atmospheric pressure. In some embodiments, the wind vane 114 may be a rotational wind vane. In some embodiments, the anemometer 116 may be a cup anemometer. In some embodiments, the wind vane 114 and the anemometer 116 may be combined in a single device such as an ultrasonic anemometer that may measure both wind speed and wind direction. In some embodiments, the wind vane 114 may be combined with a second anemometer in a single device such as an ultrasonic anemometer. The solar sensor 118 may measure solar irradiance. In some embodiments, the solar sensor 118 may be a pyranometer or a pyrheliometer. The precipitation sensor 120 may collect precipitation data and may detect the presence of precipitation. The precipitation sensor 120 may be a snow sensor, a flood sensor, or other suitable precipitation sensors. For example, the precipitation sensor 120 may be a flood sensor that measures the distance to the ground and in the presence of water the distance may decrease. In another example, the precipitation sensor 120 may be a snow sensor that measures the distance to the ground, and, as snow accumulates, the distance may decrease. In some embodiments, a snow sensor and a flood sensor may be included.

The communication of data between the various sensors and the weather controller 112 may occur through a wireless communication protocol (e.g., Bluetooth, Zigbee, thread connection, Z-wave, or other similar wireless communication protocols) or a wired communication protocol (e.g., coaxial cable, fiber optic cable, a category 5/5/e/6 network cable, RS-485 (Modbus), RS-232, or other similar wired communication protocols), depending on the configuration of the PV system 100. In some embodiments, the weather controller 112 may store the weather data.

The weather controller 112 may communicate the weather data and/or the weather controller 112 may communicate control signals based on the weather data to the first PV module controller 106a and/or the first system network controller 110a. In some embodiments, the weather controller 112 may include an auxiliary PV module 122 or another power source that may power the weather controller 112.

The first PV module controller 106a and the second PV module controller 106b (collectively the PV module controllers 106) may rotate the sets of PV modules 102. In some embodiments, multiple PV module controllers 106 may rotate a set of PV modules 102. In some embodiments, the PV module controllers 106 may rotate the sets of PV modules 102 based on weather data collected at the weather controller 112. The PV module controllers 106 may receive data from and/or send data to the system network controllers 110. For example, the first PV module controller 106a may receive data from and/or send data to the first system network controller 110a, and the second PV module controller 106b may receive data from and/or send data to the second system network controller 110b. For example, the PV module controllers 106 may receive weather data collected at the weather controller 112 from the system network controllers 110. In some embodiments, the PV module controllers 106 may send data pertaining to time, alarms, actual PV module position, target PV module position, and/or other information relating to the operation of a solar tracker system to the system network controllers 110. In some embodiments, one or more of the PV module controllers 106 may receive data directly from and/or send data directly to the weather controller 112. In some embodiments, the PV module controllers 106 may receive data from and/or send data to the weather controller 112 when the PV module controllers 106 are in the same communication system 130 as the weather controller 112. For example, the first PV module controller 106a may receive weather data directly from the weather controller 112 as both may be included in the first communication system 130a, but the second PV module controller 106b may not receive weather data directly from the weather controller 112 because the weather controller 112, as illustrated, may not be in the second communication system 130b.

In some embodiments, the PV module controllers 106 may utilize a solar algorithm to determine the Sun's position and the PV module controllers 106 may direct the motor 108 to rotate the sets of PV modules 102 based on the solar algorithm. For example, the first PV module controller 106a may utilize the solar algorithm to determine the Sun's position in the Sky and the first PV module controller 106a may cause the motor 108 to position the first set of PV modules 102a orthogonal or substantially orthogonal to the Sun's rays.

In some embodiments, the PV module controllers 106 may direct the motor 108 to rotate the sets of PV modules 102 based on the weather data. For example, the first PV module controller 106a may deviate from the solar algorithm based on the weather data (e.g., data obtained by the solar sensor 118 indicating diffuse solar irradiance) and direct the motor 108 to rotate the first set of PV modules 102a to a position other than orthogonal or substantially orthogonal to the Sun's rays (e.g., to horizontal regardless of the Sun's position).

In some embodiments, the PV module controllers 106 may direct the motor 108 to rotate the sets of PV modules 102 to a stow position based on the weather data. For example, the second PV module controller 106b may receive weather data that indicates high-winds (e.g., data from wind vane 114 and/or the anemometer 116), a hailstorm (e.g., data from the precipitation sensor 120), a snowstorm (e.g., data from the precipitation sensor 120), or other weather events from the second system network controller 110b, and the second PV module controller 106b may direct the motor 108 to rotate the second set of PV modules 102b to a stow position, which may minimize the risk of damage to the second set of PV modules 102b.

The system network controllers 110 may be communicatively coupled with one or more PV module controllers 106. For example, the first system network controller 110a may be communicatively coupled with the first PV module controller 106a and the second system network controller 110b may be communicatively coupled with the second PV module controller 106b. The system network controllers 110 may receive weather data collected from the weather controller 112 and send the weather data to the PV module controllers 106. For example, the first system network controller 110a may receive weather data collected by the various sensors of the weather controller 112 and send the weather data to the first PV module controller 106a. In some embodiments, the system network controllers 110 may receive the weather data, analyze the weather data, and generate control signals based on the weather data. In these and other embodiments, the system network controllers 110 may send the control signals to the PV module controllers 106, and the PV module controllers 106 may rotate the sets of PV modules 102 based on the control signals.

In some embodiments, the first communication system 130a and the second communication system 130b may be communicatively coupled. In some embodiments, the first system network controller 110a and the second system network controller 110b may be communicatively coupled. In some embodiments, the system network controllers 110 may communicate with one another via a cellular network standard. For example, the system network controllers 110 may communicate via a Second Generation (2G) cellular network (e.g., GPRS, EDGE), a Third Generation (3G) cellular network (e.g., UMTS, HSPA), a Fourth Generation (4G) cellular network (e.g., LTE), a Fifth Generation (5G) cellular network (e.g., NR, mmWave), or other cellular network standards. In some embodiments, the first system network controller 110a may include a first modem (not shown), and the second system network controller 110b may include a second modem (not shown). In these and other embodiments, the first modem and the second modem may communicatively couple the first system network controller 110a and the second system network controller 110b via the cellular network standard. For example, the first modem and the second modem may communicatively couple the first system network controller 110a and the second system network controller 110b via 5G.

In an example operation of the PV system 100, the weather controller 112 may collect data regarding various weather conditions such as wind speed, solar irradiance, and/or precipitation levels from one or more sensors (e.g., the wind vane 114, the anemometer 116, the solar sensor 118, and/or the precipitation sensor 120). The weather controller 112 may send the weather data and/or a control signal based on the weather data to the first system network controller 110a. The first system network controller 110a may send the weather data and/or a control signal based on the weather data to the first PV module controller 106a. The first PV module controller 106a may rotate the first set of PV modules 102 based on the weather data and/or the control signal (e.g., via the motor 108). For example, the first PV module controller 106a may rotate the first set of PV modules 102a to a stow position in response to weather data indicating a hailstorm is approaching to reduce the risk of damage to the first set of PV modules 102a.

The first system network controller 110a may send the weather data and/or a control signal based on the weather data to the second system network controller 110b via the cellular network standard (e.g., 5G). The second system network controller 110 b may send the weather data and/or a control signal based on the weather data to the second PV module controller 106b. The second PV module controller 106b may rotate the second set of PV modules 102b based on the weather data and/or the control signal. For example, the second PV module controller 106b may rotate the second set of PV modules 102b to a stow position based on weather data indicating a high wind event.

As a result, the second system network controller 110b may obtain weather data from the weather controller 112 without being in direct communication with the weather controller 112 and/or without relying on an external network. This may allow the second set of PV modules 102b to be rotated in response to changing weather conditions before an external network may be operational and/or during the construction phase. Furthermore, the second set of PV modules 102b may be rotated to a stow position in response to changing weather conditions, which may provide greater protection to the second set of PV modules 102b from damage potentially caused by adverse weather events.

Modifications, additions, or omissions may be made to the PV system 100 without departing from the scope of the present disclosure. For example, multiple sets of PV modules 102, multiple support columns 104, and/or multiple motors 108 may be used in the PV system 100. Furthermore, the communications systems 130 may include multiple PV module controllers 106 and/or multiple system network controllers 110. In some embodiments, multiple weather controllers 112 may be implemented. For example, the first communication system 130a and the second communication system 130b may both include weather controllers 112. Additionally, the weather controllers 112 may be equipped with other sensors than those described with reference to FIG. 1 depending on the particular environment, climate, season, and/or regional or local weather conditions.

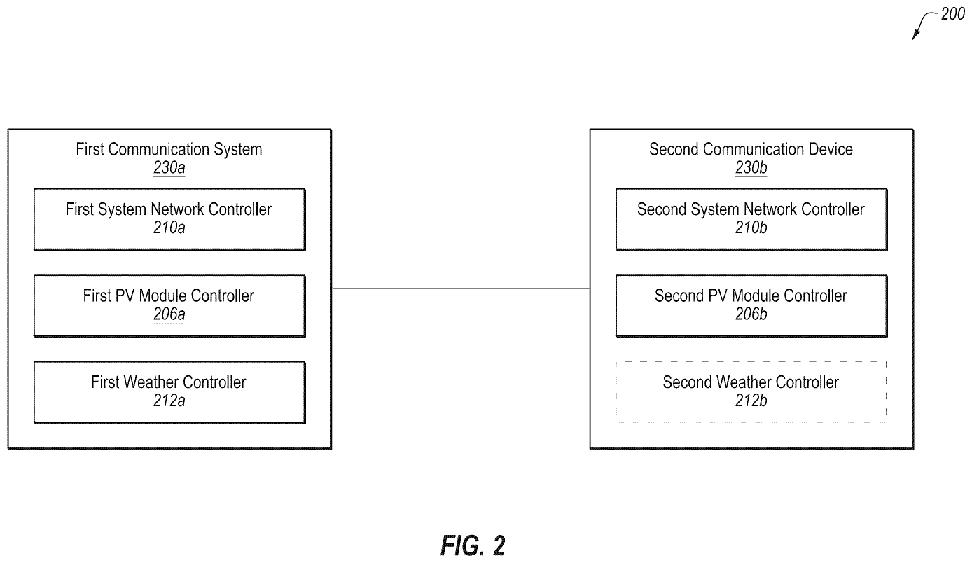

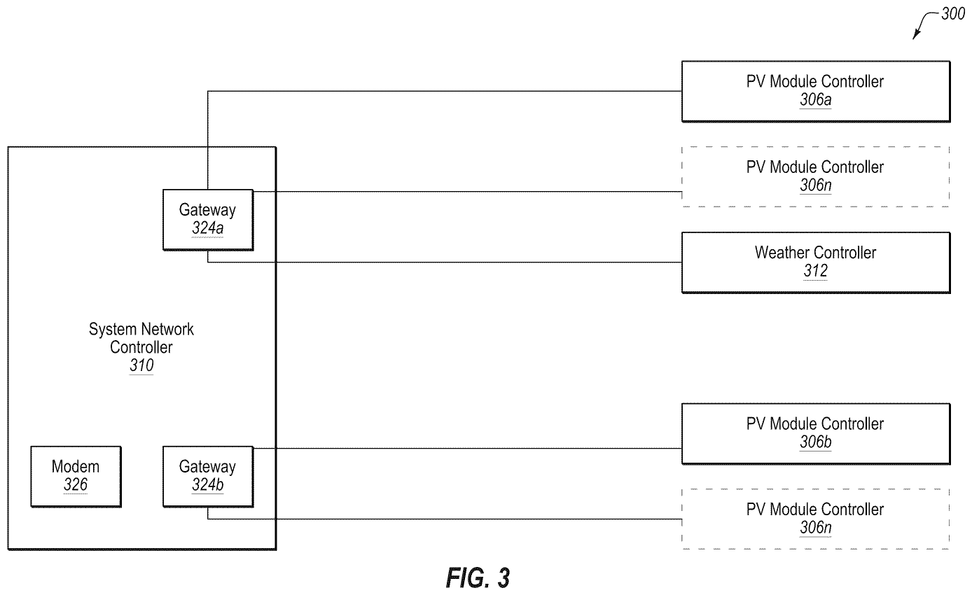

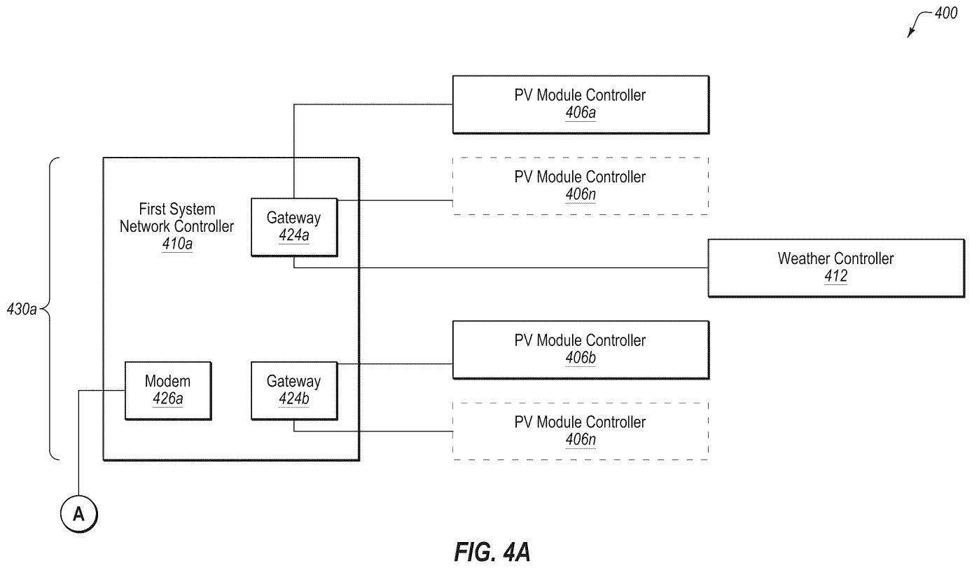

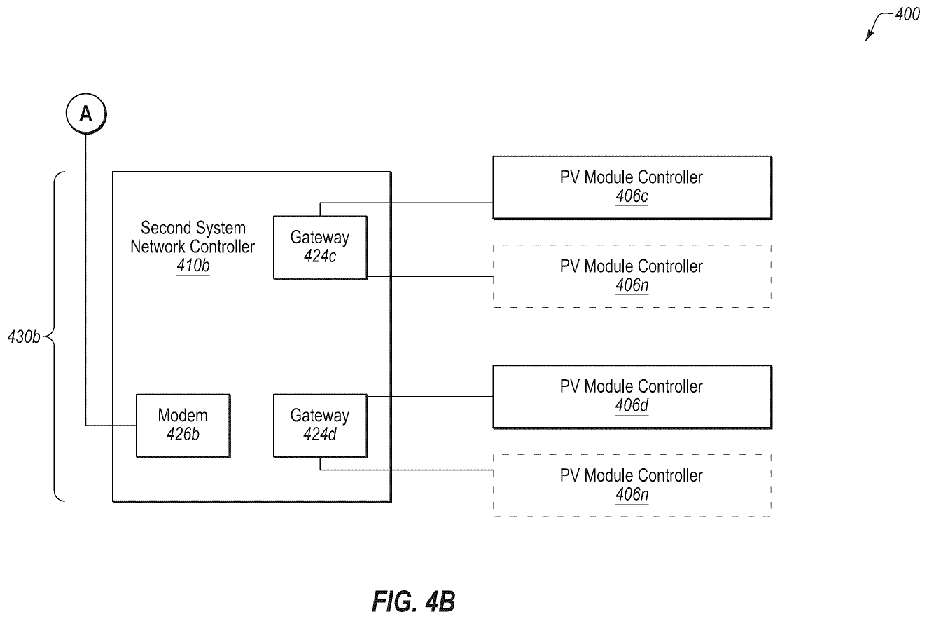

Furthermore, the components of the first communication system 130a and/or the second communication system 130b may be communicatively coupled using a wireless communication protocol (e.g., Bluetooth, Zigbee, thread connection, Z-wave, or other similar wireless communication protocols) or a wired communication protocol (e.g., coaxial cable, fiber optic cable, a category 5/5/e/6 network cable, RS-485 (Modbus), RS-232, or other similar wired communication protocols), depending on the configuration of the PV system 100. For example, and as described in more detail with reference to FIG. 2, FIG. 3, and FIGS. 4A and 4B, in each communication system 130, the PV module controllers 106 may be communicatively coupled to the system network controller 110 via Zigbee or through RS-485. In another example, the weather controller 112 may be communicatively coupled with the first system network controller 110a, the second system network controller 110b, and/or the PV module controllers 106 via Zigbee or through RS-485.

In some embodiments, the system network controllers 110, the PV module controllers 106, and/or the weather controller 112 may be powered by a generator, a PV module of the first set of PV modules 102a, a PV module of the second set of PV modules 102b, an auxiliary PV module such as the auxiliary PV module 122, and/or batteries. In some embodiments, the system network controllers 110, the PV module controllers 106, and/or the weather controller 112 may be powered with an external AC system.

FIG. 2 illustrates an example local site network 200 that may be implemented, for example, in the PV system 100 of FIG. 1. The local site network 200 may include a first communication system 230a and a second communication system 230b. The first communication system 230a and the second communication system 230b may include similar components and function similarly to communication systems described throughout this disclosure. The first communication system 230a may include a first system network controller 210a, a first PV module controller 206a, and a first weather controller 212a. The second communication system 230b may include a second system network controller 210b and a second PV module controller 206b. In some embodiments, the second communication system 230b may include a second weather controller 212b.

The first system network controller 210a, the first PV module controller 206a, and the first weather controller 212a may be communicatively coupled such that data such as weather data may be communicated between the first weather controller 212a, the first system network controller 210a, and/or the first PV module controller 206a. For example, the first weather controller 212a may collect weather data from one or more sensors such as those described with reference to FIG. 1. The first weather controller 212a may send the weather data to the first system network controller 210a, and the first system network controller 210a may send the weather data to the first PV module controller 206a. Based on the weather data, the first PV module controller 206a may cause a first set of PV modules to rotate. For example, the first PV module controller 206a may cause the first set of PV modules to rotate to a stow position based on weather data indicating a high wind event.

In some embodiments, the first system network controller 210a, the first PV module controller 206a, and/or the first weather controller 212a may be communicatively coupled via a wireless communication protocol such as Bluetooth, Zigbee, thread connection, Z-wave, or other similar protocols. In some embodiments, the first system network controller 210a, the first PV module controller 206a, and/or the first weather controller 212a may be communicatively coupled via a wired communication protocol such as by a coaxial cable, fiber optic cable, a category 5/5/e/6 network cable, RS-485 (Modbus), RS-232, or other similar wired communication protocols.

The second system network controller 210b and the second PV module controller 206b may be communicatively coupled such that data such as weather data may be communicated between the second system network controller 210b and the second PV module controller 206b. For example, the second system network controller 210b may send the second PV module controller 206b wind data indicating a high-wind event, and the second PV module controller 206b may rotate a second set of PV modules to a stow position based on the wind data. In some embodiments, the second system network controller 210b and the second PV module controller 206b may be communicatively coupled via a wireless communication protocol such as Bluetooth, Zigbee, thread connection, Z-wave, or other similar protocols. In some embodiments, the second system network controller 210b and the second PV module controller 206b may be communicatively coupled via a wired communication protocol such as by a coaxial cable, fiber optic cable, a category 5/5/e/6 network cable, RS-485 (Modbus), RS-232, or other similar wired communication protocols.

As illustrated in FIG. 2, the first communication system 230a and the second communication system 230b may be communicatively coupled. In some embodiments, the first communication system 230a and the second communication system 230b may be communicatively coupled via a cellular network standard such as, for example, a 5G cellular network standard. In some embodiments, the first communication system 230a may include a first modem (not shown) and the second communication system 230b may include a second modem (not shown). For example, the first system network controller 210a and the second system network controller 210b may each include a modem, and the modems may communicatively couple the first system network controller 210a and the second system network controller 210b via the cellular network standard. As a result, weather data may be sent from the first communication system 230a (e.g., from the first system network controller 210a) to the second communication system 230b (e.g., to the second system network controller 210b) via the cellular network standard. The second system network controller 210b may then send the weather data to the second PV module controller 206b and the second PV module controller 206b may rotate a second set of PV modules based on the weather data.

As a result, the second set of PV modules may be rotated based on the weather data such as wind data, precipitation data, or solar irradiance data even if the second communication system 230b does not include a weather controller. Furthermore, the first set of PV modules and the second set of PV modules may be rotated without an external network being constructed.

Modifications, additions, or omissions may be made to the local site network 200 without departing from the scope of the present disclosure. For example, the first communication system 230a and/or the second communication system 230b may include multiple PV module controllers 206 and/or multiple system network controllers 210. In some embodiments, multiple weather controllers 212 may be implemented. For example, the first communication system 230a may include the first weather controller 212a and the second communication system 230b may include the second weather controller 212b.

Furthermore, in some embodiments, the first system network controller 210a, the second system network controller 210b, the first PV module controller 206a, the second PV module controller 206b, the first weather controller 212a, and/or the second weather controller 212b may be powered by a generator, a PV module of the first set of PV modules, a PV module of the second set of PV modules, an auxiliary PV module, and/or batteries. In some embodiments, the system network controllers 210, the PV module controllers 206, and/or the weather controller(s) 212 may be powered with an external AC system.

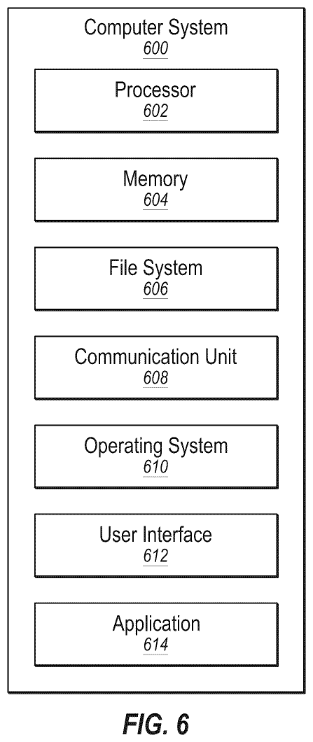

Additionally, in some embodiments, a computer system such as that described with reference to FIG. 6 may utilize the local site network 200 to monitor the solar site for weather events and/or for operational conditions.

FIG. 3 illustrates an example communication system 300. The communication system 300 may be similar to and include components that function similarly to the communication systems described throughout this disclosure. For example, the communication system 300 may include one or more PV module controllers 306, a system network controller 310, and a weather controller 312, which may be similar to similarly named components described throughout this disclosure.

The system network controller 310 may be communicatively coupled to one or more PV module controllers 306 and a weather controller 312. In some embodiments, one or more gateways 324 may communicatively couple the system network controller 310 to the PV module controllers 306 and/or the weather controller 312. For example, a first PV module controller 306a and the weather controller 312 may be communicatively coupled to the system network controller 310 via a first gateway 324a and a second PV module controller 306b may be communicatively coupled to the system network controller 310 via a second gateway 324b. The gateways 324 may be an intermediary or bridge enabling communication between two or more different communication protocols, network nodes, or network systems. For example, the gateways 324 may allow the system network controller 310 to communicate between different protocols. For instance, the system network controller 310 may communicate with the PV module controllers 306 and/or the weather controller 312 via Zigbee but may communicate with other system network controllers via a cellular network standard such as 5G. As a result, in some embodiments, the gateways 324 may allow the system network controller 310 to send and receive weather data via the cellular network standard and allow the system network controller 310 to receive weather data from the weather controller 312 and/or send weather data to the PV module controllers 306 via a wireless communication protocol like Zigbee or a wired communication protocol like RS-485.

In these and other embodiments, the weather controller 312 may send weather data to the first PV module controller 306a through the first gateway 324a included in the system network controller 310. Based on the weather data, the first PV module controller 306a may rotate a first set of PV modules. In some embodiments, the system network controller 310 may forward the weather data from the first gateway 324a to the second gateway 324b. The second gateway 324b may then send the weather data to the second PV module controller 306b. Based on the weather data, the second PV module controller 306b may rotate a second set of PV modules. Thus, the second set of PV modules may be rotated by the second PV module controller 306b without the second gateway 324b being in direct communication with the weather controller 312.

As previously discussed, the system network controller 310 may be communicatively coupled to the weather controller 312 and/or the PV module controllers 306 via a wireless communication protocol (e.g., Zigbee) and/or through a wired communication protocol (e.g., RS-485). In some embodiments, the PV module controllers 306 may be communicatively coupled with the weather controller 312 such that the PV module controllers 306 and the weather controller 312 may communicate directly. For example, the first PV module controller 306a may be communicatively coupled with the weather controller 312 such that the weather controller 312 may send weather data to the first PV module controller 306a directly. In some embodiments, the PV module controllers 306 and/or the weather controller 312 may function as repeaters. For example, in response to the connection between the system network controller 310 and the weather controller 312 failing, the weather controller 312 may route the weather data to the first PV module controller 306a, which may send (e.g., repeat) the weather data to the system network controller 310. Thus, the weather controller 312 and/or the PV module controller 306 may communicate with the system network controller 310 even with low signal strength or without a connection.

In some embodiments, the communication system 300 may not include the weather controller 312. In these and other embodiments, the communication system 300 may be communicatively coupled with a different communication system via a modem 326. In some embodiments, the system network controller 310 may include the modem 326. In some embodiments, the modem 326 may be communicatively coupled with another modem in a different communication system via a cellular network standard such as 5G. In these and other embodiments, the system network controller 310 may send and/or receive weather data via the modem 326. The system network controller 310 may then route the weather data from the modem 326 to the first PV module controller 306a via the first gateway 324a and/or from the modem 326 to the second PV module controller 306b via the second gateway 324b.

Modifications, additions, or omissions may be made to the communication system 300 without departing from the scope of the present disclosure. For example, in some embodiments, one or more of the gateways 324 may be associated with multiple PV module controllers 306. For example, the first gateway 324a may be communicatively coupled with the first PV module controller 306a and one or more other PV module controllers 306n and/or the second gateway 324b may be communicatively coupled with the second PV module controller 306b and/or one or more other PV module controllers 306n.

FIGS. 4A and 4B illustrate an example local site network 400 including a first communication system 430a (FIG. 4A) and a second communication system 430b (FIG. 4B) communicatively coupled with the first communication system 430a. The communication systems 430 may be similar to and include components that function similarly to the communication systems described throughout this disclosure. For example, the first communication system 430a may include a first system network controller 410a, one or more PV module controllers 406, and/or a weather controller 412, and the second communication system 430b may include a second system network controller 410b and/or one or more PV module controllers 406.

The first communication system 430a may include a first PV module controller 406a that may cause a first set of PV modules to rotate based on weather data from the weather controller 412 and a second PV module controller 406b that may cause a second set of PV modules to rotate based on the weather data from the weather controller 412. The first system network controller 410a may be communicatively coupled to the first PV module controller 406a, the second PV module controller 406b, and/or the weather controller 412. For example, the first system network controller 410a may be communicatively coupled to the first PV module controller 406a and the weather controller 412 via a first gateway 424a and communicatively coupled to the second PV module controller 406b via a second gateway 424b. The first system network controller 410a may send weather data received from the weather controller 412 to the first PV module controller 406a and/or the second PV module controller 406b. For example, the weather controller 412 may send weather data collected from one or more sensors (as discussed in FIG. 1) to the first gateway 424a at the first system network controller 410a. The first system network controller 410a may send the weather data to the first PV module controller 406a via the first gateway 424a and/or send the weather data to the second PV module controller 406b via the second gateway 424b.

The second communication system 430b may include a third PV module controller 406c that may cause a third set of PV modules to rotate based on weather data and a fourth PV module controller 406d that may cause a fourth set of PV modules to rotate based on weather data. The second system network controller 410b may be communicatively coupled to the third PV module controller 406c and the fourth PV module controller 406d. For example, the second system network controller 410b may be communicatively coupled to the third PV module controller 406c via a third gateway 424c and communicatively coupled to the fourth PV module controller 406d via a fourth gateway 424d.

As illustrated in FIGS. 4A and 4B, the first system network controller 410a may include a first modem 426a, and the second system network controller 410b may include a second modem 426b. The first modem 426a and the second modem 426b may communicatively couple the first system network controller 410a to the second system network controller 410b via a cellular network standard (e.g., 5G).

As illustrated in FIG. 4B, the second communication system 430b may not include a weather controller 412. Because the system network controllers 410 are communicatively coupled via the modems 426, the first system network controller 410a may send the weather data the first system network controller 410a receives from the weather controller 412 to the second system network controller 410b via a cellular network standard (e.g., 5G). The second system network controller 410b may then send the weather data to the third PV module controller 406c via the third gateway 424c to rotate the third set of PV modules and/or may send the weather data to the fourth PV module controller 406d via the fourth gateway 424d to rotate the fourth set of PV modules.

In an example operation of the local site network 400, the weather controller 412 may collect weather data via one or more sensors (e.g., the wind vane 114, the anemometer 116, the solar sensor 118, and/or the precipitation sensor 120, described with reference to FIG. 1). The weather data may include wind data, precipitation data, and/or solar irradiance data. The weather controller 412 may send the weather data to the first system network controller 410a via a wireless communication protocol such as Zigbee or a wired communication protocol such as RS-485. The first system network controller 410a may send the weather data to the one or more PV module controllers 406 that the first system network controller 410a may be associated with via a wireless communication protocol such as Zigbee or a wired communication protocol such as RS-485. For example, the first system network controller 410a may send the weather data to the first PV module controller 406a via the first gateway 424a and/or the second PV module controller 406b via the second gateway 424b.

The first system network controller 410a may send the weather data to the second system network controller 410b via the cellular network standard. For example, the first system network controller 410a may send the weather data from the first modem 426a to the second modem 426b at the second system network controller 410b via 5G. The second system network controller 410b may then send the weather data to the third PV module controller 406c via the third gateway 424c and/or to the fourth PV module controller 406d via the fourth gateway 424d. For example, the second system network controller 410b may send the weather data to the third PV module controller 406c via a wireless communication protocol such as Zigbee or a wired communication protocol such as RS-485.

In response to receiving the weather data, the PV module controllers 406 may each rotate a respective set of PV modules based on the weather data. For example, based on the weather data, the first PV module controller 406a may rotate a first set of PV modules, the second PV module controller 406b may rotate a second set of PV modules, the third PV module controller 406c may rotate the third set of PV modules, and/or the fourth PV module controller 406d may rotate the fourth set of PV modules.

The local site network 400 may allow the sets of PV modules to be rotated in response to changing weather conditions even in the absence of an external network and/or during the construction phase. This may enable faster commissioning of the PV modules such that the PV system may generate energy before an external network may be established and/or may mitigate damage to PV modules due to adverse weather conditions before an external network may be established.

Modifications, additions, or omissions may be made to the local site network 400 without departing from the scope of the present disclosure. For example, in some embodiments, one or more of the gateways 424 may be associated with multiple PV module controllers 406. For example, the first gateway 424a, the second gateway 424b, the third gateway 424c, and/or the fourth gateway 424d may be communicatively coupled with one or more other PV module controllers 406n.

Furthermore, other components may include a modem 426. For example, the weather controller 412 may include a modem. In addition, other cellular network standards other than 5G may be utilized. For example, the first system network controller 410a may be coupled to the second system network controller 410b via 2G, 3G, or 4G.

Furthermore, the components of the first communication system 430a and/or the second communication system 430b may be communicatively coupled using a wireless communication protocol (e.g., Bluetooth, Zigbee, thread connection, Z-wave, or other similar wireless communication protocols) or a wired communication protocol (e.g., coaxial cable, fiber optic cable, a category 5/5/e/6 network cable, RS-485 (Modbus), RS-232, or other similar wired communication protocols), depending on the configuration of the local site network 400.

Additionally, in some embodiments, the second communication system 430b may include another weather controller 412 and/or the first communication system 430a may omit the weather controller 412.

In some embodiments, the system network controllers 410, the PV module controllers 406, and/or the weather controller 412 may be powered by a generator, a PV module of the first set of PV modules, a PV module of the second set of PV modules, an auxiliary PV module such as the auxiliary PV module, and/or batteries. In some embodiments, the system network controllers 410, the PV module controllers 406, and/or the weather controller 412 may be powered with an external AC system.

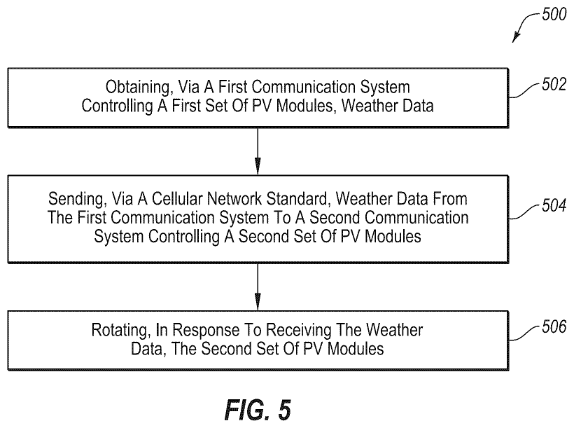

FIG. 5 illustrates a flowchart of an example method 500 of communicating between photovoltaic systems, in accordance with one or more embodiments of the present disclosure. The method 500 may be performed by any suitable system or device. For example, the method 500 may be at least partially implemented using the PV system 100 of FIG. 1, the local site network 200 of FIG. 2, the communication system 300 of FIG. 3, or the local site network 400 of FIGS. 4A and 4B. Although illustrated with discrete blocks, the steps and operations associated with one or more blocks of the method 500 may be divided into additional blocks, combined into fewer blocks, or eliminated, depending on the particular implementation.

At block 502, weather data may be obtained via a first communication system controlling a first set of PV modules. The first communication system may be similar to the communication systems described throughout this disclosure. For example, the first communication system may be similar to and perform similar functions as the communication systems 130, 230, 300, and 430 respectively described with reference to FIGS. 1-4. For instance, the first communication system 130a controlling the first set of PV modules 102a may obtain weather data. In some embodiments, the method 500 may further include rotating, in response to obtaining the weather data, the first set of PV modules.

At block 504, the weather data may be sent from the first communication system to a second communication system controlling a second set of PV modules via a cellular network standard. The second communication system may be similar to the communication systems described throughout this disclosure. For example, the second communication system may be similar to and perform similar functions as the communication systems 130, 230, 300, and 430 respectively described with reference to FIGS. 1-4. For instance, the weather data may be sent from the first communication system 130a to the second communication system 130b.

In some embodiments, the first communication system may include a weather controller configured to collect the weather data, a first PV module controller configured to cause the first set of PV modules to rotate based on the weather data, and a first system network controller communicatively coupled to the weather controller and the first PV module controller. In these and other embodiments, the first system network controller may be configured to send the weather data to the first PV module controller and to send the weather data to the second communication system via the cellular network standard. In these and other embodiments, the first system network controller may include a first modem.

In some embodiments, the second communication system may include a second PV module controller configured to cause the second set of PV modules to rotate based on the weather data, and a second system network controller communicatively coupled to the second PV module controller and configured to send the weather data to the second PV module controller. In these and other embodiments, the second system network controller may include a second modem. The first modem and the second modem may communicatively couple the first system network controller and the second system network controller via the cellular network standard. In some embodiments, the cellular network standard may be 5G.

In some embodiments, the first system network controller may include a first gateway communicatively coupling the first system network controller to the first PV module controller and/or the weather controller. In some embodiments, the second system network controller may include a second gateway communicatively coupling the second system network controller to the second PV module controller.

In some embodiments, the first PV module controller, the first system network controller, and/or the weather controller may be communicatively coupled via a wireless communication protocol. In some embodiments, the second system network controller and the second PV module controller may be communicatively coupled via a wireless communication protocol.

At block 506, the second set of PV modules may be rotated in response to receiving the weather data. For example, the second set of PV modules 102b may be rotated in response to receiving the weather data. In some embodiments, the weather data may include wind data, precipitation data, and/or solar irradiance data.

Modifications, additions, or omissions may be made to the method 500 without departing from the scope of the disclosure. For example, the designations of different elements in the manner described is meant to help explain concepts described herein and is not limiting. Further, the method 500 may include any number of other elements or may be implemented within other systems or contexts than those described.

For example, in some embodiments, the first system network controller and/or the second system network controller may be powered by a generator, a PV module of the first set of PV modules, a PV module of the second set of PV modules, an auxiliary PV module, or batteries.

FIG. 6 illustrates an example computer system 600 that may be employed in communicating between photovoltaic systems. In some embodiments, the computer system 600 may be part of any of the systems or devices described in this disclosure. For example, the computer system 600 may be part of any of the communication systems 130, 230, 300, or 430 of FIGS. 1-4, the system network controllers 110, 210, 310, or 410 of FIGS. 1-4, the PV module controllers 106, 206, 306, or 406 of FIGS. 1-4, the weather controllers 112, 212, 312, or 412 of FIGS. 1-4, and/or the local site networks 200 or 400 of FIG. 2 or FIGS. 4A and 4B.

The computer system 600 may include a processor 602, a memory 604, a file system 606, a communication unit 608, an operating system 610, a user interface 612, and an application 614, which all may be communicatively coupled. In some embodiments, the computer system 600 may be, for example, a desktop computer, a client computer, a server computer, a mobile phone, a laptop computer, a smartphone, a smartwatch, a tablet computer, a portable music player, a networking device, or any other computer system.

Generally, the processor 602 may include any suitable special-purpose or general-purpose computer, computing entity, or processing device including various computer hardware or software applications and may be configured to execute instructions stored on any applicable computer-readable storage media. For example, the processor 602 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data, or any combination thereof. In some embodiments, the processor 602 may interpret and/or execute program instructions and/or process data stored in the memory 604 and/or the file system 606. In some embodiments, the processor 602 may fetch program instructions from the file system 606 and load the program instructions into the memory 604. After the program instructions are loaded into the memory 604, the processor 602 may execute the program instructions. In some embodiments, the instructions may include the processor 602 performing one or more of the actions of the methods disclosed herein.

The memory 604 and the file system 606 may include computer-readable storage media for carrying or having stored thereon computer-executable instructions or data structures. Such computer-readable storage media may be any available non-transitory media that may be accessed by a general-purpose or special-purpose computer, such as the processor 602. By way of example, and not limitation, such computer-readable storage media may include non-transitory computer-readable storage media including Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage media which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 602 to perform a certain operation or group of operations, such as one or more of the actions of the methods disclosed herein. These computer-executable instructions may be included, for example, in the operating system 610, in one or more applications, or in some combination thereof.

The communication unit 608 may include any component, device, system, or combination thereof configured to transmit or receive information over a network, such as the local site network 200 of FIG. 2 or the local site network 400 of FIGS. 4A and 4B. In some embodiments, the communication unit 608 may communicate with other devices at other locations, the same location, or even other components within the same system. For example, the communication unit 608 may include a modem, a network card (wireless or wired), an infrared communication device, a wireless communication device (such as an antenna), and/or chipset (such as a Bluetooth device, an 802.6 device (e.g., Metropolitan Area Network (MAN)), a WiFi device, a WiMax device, a cellular communication device, etc.), and/or the like. The communication unit 608 may permit data to be exchanged with a network and/or any other devices or systems, such as those described in the present disclosure.

The operating system 610 may be configured to manage hardware and software resources of the computer system 600 and configured to provide common services for the computer system 600.

The user interface 612 may include any device configured to allow a user to interface with the computer system 600. For example, the user interface 612 may include a display, such as an LCD, LED, or other display, that is configured to present video, text, application user interfaces, and other data as directed by the processor 602. The user interface 612 may further include a mouse, a track pad, a keyboard, a touchscreen, volume controls, other buttons, a speaker, a microphone, a camera, any peripheral device, or other input or output device. The user interface 612 may receive input from a user and provide the input to the processor 602. Similarly, the user interface 612 may present output to a user.

The application 614 may be one or more computer-readable instructions stored on one or more non-transitory computer-readable media, such as the memory 604 or the file system 606, that, when executed by the processor 602, is configured to perform one or more of the actions of the methods disclosed herein. In some embodiments, the application 614 may be part of the operating system 610 or may be part of an application of the computer system 600, or may be some combination thereof.

The various features illustrated in the drawings may be, but are not necessarily, drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” among others).

Relative terms used in the present disclosure and especially in the appended claims (e.g., bodies of the appended claims) are generally intended as falling within manufacturing tolerances and/or within scope reasonably understood by a person of skill in the art. For example, if two components are identified as being the “same” size, there may be variations consistent with manufacturing variances. Terms describing “approximately,” “similar,” “substantially,” or other terms designating similarity may convey within ten percent of the comparative value. For example, two components that are approximately the same size would be understood to be of a size within ten percent of each other.

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absent a showing that the terms “first,” “second,” “third,” etc., connote a specific order, these terms should not be understood to connote a specific order. Furthermore, absent a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A local site network for controlling a solar tracking system, the local site network comprising:
a first communication system, the first communication system including:
a first photovoltaic module (PV) controller configured to cause a first set of PV modules to rotate based on weather data; and
a first system network controller communicatively coupled to the first PV module controller and configured to send the weather data to the first PV module controller, the first system network controller including a first modem; and
a second communication system communicatively coupled to the first communication system, the second communication system including:
a second photovoltaic module (PV) controller configured to cause a second set of PV modules to rotate based on the weather data; and
a second system network controller, the second system network controller communicatively coupled to the second PV module controller and configured to send the weather data to the second PV module controller, the second system network controller including a second modem;
wherein the first modem and the second modem communicatively couple the first system network controller and the second system network controller via a cellular network standard.

2. The local site network of claim 1, the first communication system further comprising:
a weather controller communicatively coupled to the first system network controller and configured to collect the weather data, the first system network controller configured to send the weather data to the second system network controller via the cellular network standard.

3. The local site network of claim 2, wherein the first system network controller further includes a gateway communicatively coupling the first system network controller to at least one of the weather controller or the first PV module controller.

4. The local site network of claim 2, wherein at least two of the first PV module controller, the weather controller, or the first system network controller are communicatively coupled via a wireless communication protocol.

5. The local site network of claim 1, wherein the weather data includes at least one of: wind data, precipitation data, or solar irradiance data.

6. The local site network of claim 1, wherein the first system network controller further includes a first gateway communicatively coupling the first system network controller to the first PV module controller, and wherein the second system network controller further includes a second gateway communicatively coupling the second system network controller to the second PV module controller.

7. The local site network of claim 1, wherein the cellular network standard is 5G.

8. The local site network of claim 1, wherein at least one of the first PV module controller and the first system network controller or the second PV module controller and the second system network controller are communicatively coupled via a wireless communication protocol.

9. A photovoltaic (PV) system, the PV system comprising:
a first set of PV modules;
a first communication system configured to cause the first set of PV modules to rotate, the first communication system comprising:
a first photovoltaic (PV) module controller configured to cause the first set of PV modules to rotate based on weather data; and
a first system network controller communicatively coupled to the first PV module controller and configured to send the weather data to the first PV module controller, the first system network controller including a first modem;
a second set of PV modules; and
a second communication system communicatively coupled to the first communication system and configured to cause the second set of PV modules to rotate, the second communication system comprising:
a second photovoltaic (PV) module controller configured to cause the second set of PV modules to rotate based on the weather data; and
a second system network controller, the second system network controller communicatively coupled to the second PV module controller and configured to send the weather data to the second PV module controller, the second system network controller including a second modem;
wherein the first modem and the second modem communicatively couple the first system network controller and the second system network controller via a cellular network standard.

10. The PV system of claim 9, wherein the first communication system further comprises:
a weather controller communicatively coupled to the first system network controller and configured to collect the weather data, the first system network controller configured to send the weather data to the second system network controller via the cellular network standard.

11. The PV system of claim 10, wherein the first system network controller further includes a gateway communicatively coupling the first system network controller to at least one of the weather controller or the first PV module controller.

12. The PV system of claim 10, wherein at least two of the first PV module controller, the weather controller, or the first system network controller are communicatively coupled via a wireless communication protocol.

13. The PV system of claim 9, wherein the weather data includes at least one of: wind data, precipitation data, or solar irradiance data.

14. The PV system of claim 9, wherein the first system network controller further includes a first gateway communicatively coupling the first system network controller to the first PV module controller, and wherein the second system network controller further includes a second gateway communicatively coupling the second system network controller to the second PV module controller.

15. The PV system of claim 9, wherein the cellular network standard is 5G.

16. The PV system of claim 9, wherein at least one of the first PV module controller and the first system network controller or the second PV module controller and the second system network controller are communicatively coupled via a wireless communication protocol.

17. A method of communicating between photovoltaic systems, the method comprising:
obtaining, via a first communication system controlling a first set of PV modules, weather data;
sending, via a cellular network standard, weather data from the first communication system to a second communication system controlling a second set of PV modules; and
rotating, in response to receiving the weather data, the second set of PV modules.

18. The method of communicating between photovoltaic systems of claim 17, further comprising rotating, in response to obtaining the weather data, the first set of PV modules.

19. The method of communicating between photovoltaic systems of claim 17, wherein:
the first communication system comprises:
a weather controller configured to collect the weather data;
a first photovoltaic module (PV) controller configured to cause the first set of PV modules to rotate based on the weather data; and
a first system network controller communicatively coupled to the weather controller and the first PV module controller, the first system network controller configured to send the weather data to the first PV module controller and to send the weather data to the second communication system via the cellular network standard, the first system network controller including a first modem, and wherein the second communication system comprises:
a second photovoltaic module (PV) controller configured to cause the second set of PV modules to rotate based on the weather data; and
a second system network controller, the second system network controller communicatively coupled to the second PV module controller and configured to send the weather data to the second PV module controller, the second system network controller including a second modem;
wherein the first modem and the second modem communicatively couple the first system network controller and the second system network controller via the cellular network standard.

20. The method of communicating between photovoltaic systems of claim 17, wherein the cellular network standard is 5G.
